(19) United States
(12) Patent Application Publication
(10) Pub. No.: US 2022/0086404 A1
(43) Pub. Date: Mar. 17, 2022

(54) DYNAMIC PROJECTION METHOD FOR TARGET TRACKING AND A DYNAMIC PROJECTION EQUIPMENT

(71) Applicant: IVIEW DISPLAYS (SHENZHEN) COMPANY LTD., Shenzhen (CN)

(72) Inventors: Wenxiang Li, Shenzhen (CN); Mingnei Ding, Shenzhen (CN); Steve Yeung, Hong Kong (CN); Zhiqiang Gao, Hong Kong (CN)

(21) Appl. No.: 17/505,878

(22) Filed: Oct. 20, 2021

Related U.S. Application Data
(63) Continuation of application No. PCT/CN2020/125920, filed on Nov. 2, 2020.

(30) Foreign Application Priority Data
Sep. 17, 2020 (CN) 202010981118.2

(51) Int. Cl. H04N 9/31

(52) U.S. Cl. CPC H04N 9/3141

(57) ABSTRACT

The present application discloses a dynamic projection method for target tracking and a dynamic projection device. A dynamic projection method for target tracking includes: acquiring position information of a target; determining three-dimensional spatial coordinates of the target in a first coordinate system based on the position information of the target; determining three-dimensional spatial coordinates of the target in a second coordinate system based on the three-dimensional spatial coordinates of the target in the first coordinate system; determining a deflection angle of a projection screen based on the three-dimensional spatial coordinates of the target in the second coordinate system; determining a rotation angle of a dynamic control unit based on the deflection angle; controlling the dynamic control unit to rotate by the rotation angle; and controlling a projecting unit to project the projection screen. In this way, dynamic projection for target tracking is implemented.

### TECHNICAL FIELD

The present application relates to the technical field of digital projection and display, and in particular, relates to a dynamic projection method for target tracking and a dynamic projection equipment.

### BACKGROUND

In recent years, with rapid development of semiconductor and display technologies, the projection technology is quickly advanced, and more and more projection equipment are available in the market. At present, the dynamic projection technology is desired in various application scenarios, for example, large-scale stages, security and alarming, smart traffic, and the like. Specific demands in different scenarios are accommodated by movement of the projection screen in the space.

### SUMMARY

In view of the above technical problem, the present application provides a dynamic projection method for target tracking and a dynamic projection equipment, such that a projection screen follows a target during movement.

Embodiments of the present application provide a dynamic projection method for target tracking, applicable to a dynamic projection equipment, the dynamic projection equipment including a dynamic control unit and a projecting unit, the dynamic control unit being configured to control rotation of the projecting unit, wherein the method includes:

acquiring position information of a target;

determining three-dimensional spatial coordinates of the target in a first coordinate system based on the position information of the target;

determining three-dimensional spatial coordinates of the target in a second coordinate system based on the three-dimensional spatial coordinates of the target in the first coordinate system;

determining a deflection angle of a projection screen based on the three-dimensional spatial coordinates of the target in the second coordinate system;

determining a rotation angle of the motion control unit based on the deflection angle;

controlling the motion control unit to rotate by the rotation angle;

controlling the projecting unit to project the projection screen.

Embodiments of the present application further provide a dynamic projection equipment, includes:

a sensing unit, a calculating unit, a motion control unit, a projecting unit, and a controller; wherein

the sensing unit is connected to the calculating unit, the calculating unit is connected to the motion control unit, the motion control unit is connected to the projecting unit, and the controller is connected to the sensing unit, the calculating unit, the motion control unit, and the projecting unit;

the sensing unit is configured to acquire position information of a target;

the calculating unit is configured to calculate three-dimensional spatial coordinates and a rotation angle desired by the motion control unit; and

the motion control unit is configured to control the projecting unit to rotate;

wherein the controller includes:

at least one processor; and

a memory communicably connected to the at least one processor; wherein

the memory is configured to store at least one instruction executable by the at least one processor, wherein the at least one instruction, when executed by the at least one processor, causes the at least one processor to perform the method as described above.

Embodiments of the present application further provide non-volatile computer-readable storage medium storing at least one computer-executable instruction, wherein the at least one computer-executable instruction, when executed by a processor, causes the processor to perform the method as described above.

Embodiments of the present application further provide a computer program product comprising a computer program stored in a non-volatile computer-readable storage medium, wherein the computer program comprises at least one program instruction, which, when executed by a dynamic projection equipment, causes the dynamic projection equipment to perform the method as described above.

As compared with the related art, the present application achieves the following beneficial effects: In the dynamic projection method for target tracking and the dynamic projection equipment according to the present application, position information of a target is acquired; three-dimensional spatial coordinates of the target in a first coordinate system are determined based on the position information of the target; three-dimensional spatial coordinates of the target in a second coordinate system are determined based on the three-dimensional spatial coordinates of the target in the first coordinate system; a deflection angle of a projection screen is determined based on the three-dimensional spatial coordinates of the target in the second coordinate system; a rotation angle of a motion control unit is determined based on the deflection angle; the motion control unit is controlled to rotate by the rotation angle; and a projecting unit is controlled to project the projection screen. By the above process, the three-dimensional spatial coordinates of the target and the rotation angle of the motion control unit are determined, and the motion control unit is controlled to rotate by the rotation angle such that the projecting unit is controlled to project a screen to a position of the target. In this way, dynamic projection for target tracking is implemented.

### BRIEF DESCRIPTION OF THE DRAWINGS

One or more embodiments are illustrated by way of example, and not by limitation, in the figures of the accompanying drawings, wherein components having the same reference numeral designations represent like components throughout. The drawings are not to scale, unless otherwise disclosed.

FIG. 1 is a schematic structural diagram illustrating hardware of a dynamic projection equipment according to an embodiment of the present application;

FIG. 2 is a schematic flowchart of a dynamic projection method for target tracking according to an embodiment of the present application;

FIG. 3 is a schematic diagram illustrating transformation of three-dimensional spatial coordinates of a target in a first coordinate system according to an embodiment of the present application;

FIG. 4 is a schematic diagram illustrating transformation of three-dimensional spatial coordinates of a target in a first coordinate system and a second coordinate system according to an embodiment of the present application;

FIG. 5 is a schematic structural diagram of a dynamic projection device for target tracking according to an embodiment of the present application;

FIG. 6 is a schematic structural diagram illustrating hardware of a controller according to an embodiment of the present application.

### DETAILED DESCRIPTION

For clearer descriptions of the objectives, technical solutions, and advantages of the embodiments of the present application, the following clearly and completely describes the technical solutions in the embodiments of the present application with reference to the accompanying drawings in the embodiments of the present application. Apparently, the described embodiments are merely a part rather than all of the embodiments of the present application. All other embodiments obtained by a person of ordinary skill in the art based on the embodiments of the present application without creative efforts shall fall within the protection scope of the present application.

It should be noted that, in the absence of conflict, embodiments of the present application and features in the embodiments may be incorporated, which all fall within the protection scope of the present application. In addition, although logic function module division is illustrated in the schematic diagrams of apparatuses, and logic sequences are illustrated in the flowcharts, in some occasions, steps illustrated or described by using modules different from the module division in the apparatuses or in sequences different from those illustrated. Further, the terms “first,” “second,” and “third” used in this text do not limit data and execution sequences, and are intended to distinguish identical items or similar items having substantially the same functions and effects.

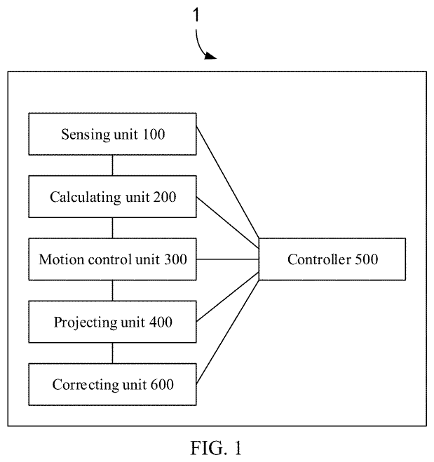

An embodiment of the present application provides a dynamic projection equipment. Referring to FIG. 1, a schematic structural diagram illustrating hardware of a dynamic projection equipment 1 according to an embodiment of the present application is illustrated. The dynamic projection equipment 1 includes a sensing unit 100, a calculating unit 200, a motion control unit 300, a projecting unit 400, and a controller 500. The sensing unit 100 is connected to the calculating unit 200, the calculating unit 200 is connected to the motion control unit 300, the motion control unit 300 is connected to the projecting unit 400, and the controller 500 is connected to the sensing unit 100, the calculating unit 200, the motion control unit 300, and the projecting unit 400.

The sensing unit 100 may be any type of sensor having a deep perception capability. The sensing unit 100 has a wide detection range. Detection angles in horizontal and vertical directions both exceed 90 degrees, even reaching 180 degrees. The sensing unit 100 may be, for example, a 3D camera, a microwave radar, or the like. The sensing unit 100 is configured to detect presence of a target, and acquire position information of the target.

The calculating unit 200 may be any type of equipment having a calculation capability, for example, a small-size computer, or a microcontroller unit, or the like. The calculating unit 200 is configured to calculate three-dimensional spatial coordinates and a rotation angle desired by the motion control unit 300 based on the position information of the target.

The motion control unit 300 may be any type of equipment capable of rotating in the horizontal and vertical directions, for example, a pan-tilt-zoom camera or a multi-dimensional dynamic platform. The motion control unit 300 is configured to control the projecting unit 400 to rotate. For accurate acquisition of a rotation angle of the motion control unit, the motion control unit 300 includes a rotation shaft, a motor, and a coder. The motor may be a stepping motor or a servo motor. The motor is connected to the rotation shaft and the coder, the motor drives the rotation shaft to rotate, and the coder is configured to record a rotation position of the motor.

The projecting unit 400 may be any type of equipment having a projection function. The projecting unit 400 may be, for example, a long-focus projector optical engine. The long-focus projector optical engine is capable of ensuring projection of a projection screen to a distant position, and ensuring an appropriate screen and brightness. The projecting unit 400 is configured to project an image, a video, or a Unity animation, or the like content.

The controller 500 is configured to control the sensing unit 100 to acquire the position information of the target, configured to control the calculating unit to calculate the three-dimensional spatial coordinates and the rotation angle based on the position information, and further configured to control the motion control unit to control the projecting unit to rotate and control the projecting unit to project a screen.

In some other embodiments of the present application, movement of the projection screen may be controlled in two ways. The projecting unit 400 is mounted on the motion control unit 300, and the movement of the projection screen is controlled by rotating the projecting unit 400. Alternatively, the dynamic projection equipment 1 further includes a reflective mirror. The reflective mirror is mounted on the motion control unit 300, and is placed to be vertical to the projecting unit 400, and the movement of the projection screen is controlled by rotating the reflective mirror. It should be noted that when the reflective mirror is placed to be vertical to the projecting unit 400, the reflective mirror needs to have a high reflectivity, for example, a light incident angle is less than or equal to 45 degrees, and the reflectivity is greater than or equal to 99%.

In some other embodiments of the present application, the dynamic projection equipment 1 further includes a correcting unit 600. The correcting unit 600 may be any type of equipment having a correction function, for example, a correction instrument. The correcting unit 600 is connected to the projecting unit 400 and the controller 500. The correcting unit 600 is configured to correct the projection screen, for example, automatic focusing, such that the projection screen remains clear.

In some other embodiments of the present application, the dynamic projection equipment further includes a lens (not illustrated) and a focusing unit (not illustrated). The lens is connected to the focusing unit. The focusing unit is connected to the controller 600. The controller controls the focusing unit to move the lens to a focusing position, such that automatic focusing is implemented.

The projection method for target tacking according to the present application has an extensive application prospect. For example, the method may be applicable to security, commerce, entertainment, and the like scenarios.

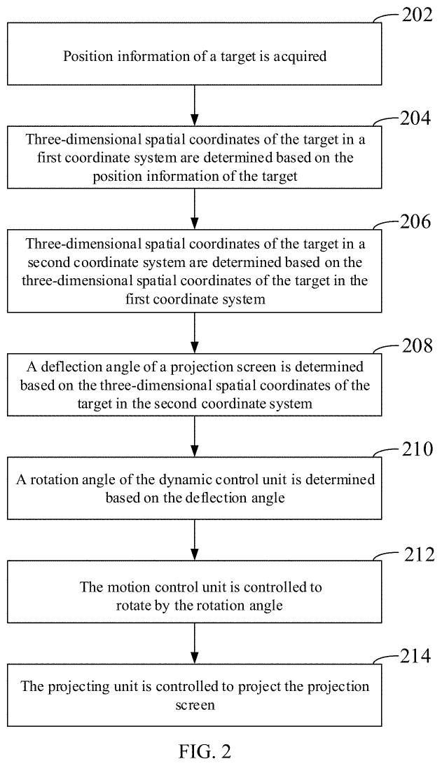

As illustrated in FIG. 2, an embodiment of the present application provides a projection method for target tracking, applicable to a dynamic projection equipment. The method is performed by a controller. The method includes:

In step 202, position information of a target is acquired.

In the embodiment of the present application, the target refers to an object of interest in a specific application scenario. For example, in a security scenario, the target refers to a person or an animal entering a protected region; and in a stage scenario, the target refers to an actor or actress. The position information of the target includes a distance, an azimuth, and an elevation angle; wherein the distance is a length between the sensing unit and the target, the azimuth is a horizontal angle between the sensing unit and the target, and the elevation angle is a vertical angle between the sensing unit and the target.

Specifically, presence of the target is detected by the sensing unit. When the target is detected, the position information of the target may be acquired. It should be noted that during simultaneous detection of a plurality of targets, one of these targets may be selected as the target of interest in accordance with a suitable criterion. For example, a target with a minimum distance or a minimum azimuth may be selected as the target of interest.

In step 204, three-dimensional spatial coordinates of the target in a first coordinate system are determined based on the position information of the target.

In the embodiment of the present application, the first coordinate system and a second coordinate system hereinafter are merely defined for illustration of the present application, and are relative concepts, which are not intended to limit the present application. The first coordinate system may be, for example, a Cartesian coordinate system. Specifically, after the position information of the target is acquired, the position information is sent to the calculating unit, such that the calculating unit determines the three-dimensional spatial coordinates of the target in the first coordinate system based on the position information of the target.

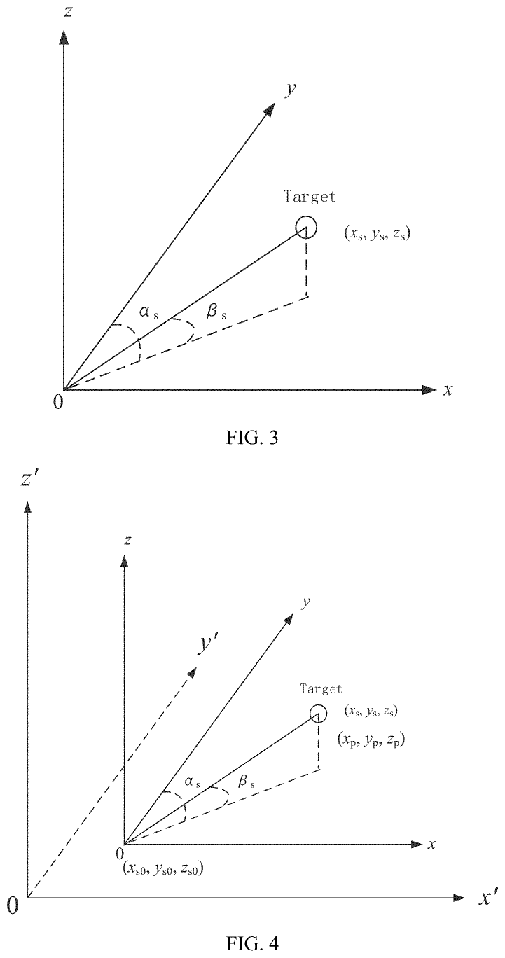

In some other embodiments of the present application, as a practice of step 204, as illustrated in FIG. 3, the first coordinate system, that is, the Cartesian coordinate system Oxyz, is established with the sensor as an origin, and the three-dimensional spatial coordinates of the target in the first coordinate system are calculated based on the distance Rₛ, the azimuth αₛ, and the elevation angle βₛ by using formula (1) as follows:

xₛ=Rₛ cos βₛ sin αₛ

yₛ=Rₛ cos βₛ cos αₛ

zₛ=Rₛ sin βₛ (1);

wherein xₛ, yₛ, zₛ are the three-dimensional coordinates of the target in the first coordinate system, Rₛ is a length, that is, the distance, between the sensing unit and the target, αₛ is a horizontal angle, that is, the azimuth, between the sensing unit and the target, and βₛ is a vertical angle, that is, the elevation angle, between the sensing unit and the target. The three-dimensional spatial coordinates of the target in the first coordinate system may be calculated by using the above formula.

In step 206, three-dimensional spatial coordinates of the target in a second coordinate system are determined based on the three-dimensional spatial coordinates of the target in the first coordinate system.

In the embodiment of the present application, the second coordinate system is a Cartesian coordinate system 0x′y′z′ established with an axial center of a rotation shaft of the motion control unit as an origin. Specifically, after the three-dimensional spatial coordinates of the target in the first coordinate system are calculated, the three-dimensional spatial coordinates of the target in the second coordinate system may be determined based on the three-dimensional spatial coordinates of the target in the first coordinate system.

In some other embodiments of the present application, as a practice of step 206, as illustrated in FIG. 4, the second coordinate system is established with the axial center of the rotation shaft as the origin, the second coordinate system is in a corresponding relationship with the first coordinate system, and then the three-dimensional spatial coordinates of the target in the second coordinate system are determined based on the three-dimensional spatial coordinates of the target in the first coordinate system and the corresponding relationship. For ease of calculation, the first coordinate system Oxyz may be maintained parallel to the second coordinate system 0x′y′z′. Specifically, coordinates of the sensor in the second coordinate system 0x′y′z′ are (xₛ₀, yₛ₀, zₛ₀), parameters xₛ₀, yₛ₀, zₛ₀ may be determined according to the structure of the products, and these three parameters may be acquired in advance by measurement. Further, the three-dimensional spatial coordinates of the target in the second coordinate system are calculated by using formula (2) as follows:

xₚ=xₛ+xₛ₀=R_{S} cos βₛ sin αₛ+xₛ₀

yₚ=yₛ+yₛ₀=R_{S} cos βₛ cos αₛ+yₛ₀

zₚ=zₛ+zₛ₀=R_{S} sin βₛ+zₛ₀ (2);

wherein xₚ, yₚ, zₚ are the three-dimensional spatial coordinates of the target in the second coordinate system, and xₛ₀, yₛ₀, zₛ₀ are coordinates of the sensing unit in the second coordinate system. The three-dimensional spatial coordinates of the target in the second coordinate system may be calculated by using the above formula.

In step 208, a deflection angle of a projection screen is determined based on the three-dimensional spatial coordinates of the target in the second coordinate system.

In the embodiment of the present application, the deflection angle of the projection screen may be interpreted as a reflection angle of the target relative to the projecting unit. Specifically, after the three-dimensional spatial coordinates (xₚ, yₚ, zₚ) of the target in the second coordinate system are determined, the deflection angle of the target relative to the projecting unit may be determined. Specifically, the deflection angle may be calculated by using formula (3) as follows:

$${α}_{p} = {sin}^{- 1} \frac{{x}_{p}}{\sqrt{{x}_{p}^{2} + {y}_{p}^{2}}} = {cos}^{- 1} \frac{{y}_{p}}{\sqrt{{x}_{p}^{2} + {y}_{p}^{2}}} \\ {β}_{p} = {sin}^{- 1} \frac{{z}_{p}}{\sqrt{{x}_{p}^{2} + {y}_{p}^{2} + {z}_{p}^{2}}} ; \qquad ( 3 )$$

wherein αₚ, βₚ is the deflection angle of the projection screen relative to the projecting unit.

In step 210, a rotation angle of the dynamic control unit is determined based on the deflection angle.

Specifically, after the three-dimensional spatial coordinates of the target in the second coordinate system are acquired, two angle sequences αₚ⁽ⁱ⁾, i=1, 2, . . . , n and βₚ⁽ⁱ⁾, i=1, 2, . . . , n may be established. Exemplarily, assuming that the deflection angles of the current projection screen are αₚ⁽ⁱ⁾ and βₚ⁽ⁱ⁾, then at a next moment when the motion control unit needs to be rotated, the deflection angles corresponding to the target are αₚ⁽ⁱ⁺¹⁾ and βₚ⁽ⁱ⁺¹⁾; and in this case, the rotation angle desired by the motion control unit is calculated by formula (4) as follows:

Δα=αₚ⁽ⁱ⁺¹⁾−αₚ⁽ⁱ⁾

Δβ=βₚ⁽ⁱ⁺¹⁾−βₚ⁽ⁱ⁾ (4)

wherein αₚ⁽ⁱ⁾ and βₚ⁽ⁱ⁾ are the deflection angles of the projection screen, αₚ⁽ⁱ⁺¹⁾ and βₚ⁽ⁱ⁺¹⁾ are deflection angles corresponding to the target, Δα is a rotation angle of the motion control unit in a horizontal direction, and Δβ is a rotation angle of the motion control unit in a vertical direction. The deflection angles of the motion control unit in the horizontal and vertical directions may be calculated by using the above formula.

It may be understood that in some other embodiments of the present application, when the sensing unit is relatively proximal to the axial center of the rotation shaft of the motion control unit, relative to the distance to the target, the distance between the sensing unit to the axial center of the rotation shaft of the motion control unit may be ignored. In this case, it may be considered that the first coordinate system is in coincidence with the second coordinate system. In this case, the azimuth and the elevation angle of the target in the first coordinate system may be considered as the azimuth and the elevation angle of the target in the second coordinate system, that is, αₚ≈αₛ and βₚ≈βₛ. In this case, the angle by which the motion control unit needs to be rotated may be calculated by directly using the formulae Δα=αₛ⁽ⁱ⁺¹⁾−αₛ⁽ⁱ⁾ and Δβ=βₛ⁽ⁱ⁺¹⁾−βₛ⁽ⁱ⁾.

In some other embodiments of the present application, the sensing unit 100 and the projecting unit 400 may be placed on the same rotation mechanism. In this case, the sensing unit 100 and the projecting unit 400 may rotate simultaneously in the same direction, and a fixed distance is constantly maintained therebetween. In this case, the coordinate system of the sensing unit may vary with the rotation of the motion control unit. For ease of calculation, upon completion of each rotation of the motion control unit, the first coordinate system and the second coordinate system are reestablished, such that these two coordinate systems are maintained parallel to each other and relative positions thereof are maintained unchanged.

In step 212, the motion control unit is controlled to rotate by the rotation angle.

In step 214, the projecting unit is controlled to project the projection screen.

Specifically, after the rotation angles of the motion control unit in the horizontal and vertical directions are acquired, the controller may control the motion control unit to rotate by the rotation angles, such that the projecting unit is controlled to project the projection screen. Specifically, the projecting unit is controlled to move the projection screen to the position of the target. It may be understood that in some other embodiments, the motion control unit may directly control the projecting unit to move, or may control the reflective mirror placed vertical to the projecting unit to rotate. Likewise, the projection screen may also be moved to the position of the target.

In some other embodiments of the present application, since the projection screen may be tilted or deflected during the movement, the projection screen needs to be corrected. The method further includes: correcting the projection screen.

Specifically, a corresponding relationship table may be acquired by presetting a corresponding relationship between a projection distance and a focusing position of the lens. In the corresponding relationship table, each projection distance may have a unique optimal lens position, such that the projection screen is the clearest. Specifically, the position of the projection screen is acquired, the projection distance is determined based on the position, and after the projection distance is acquired, the focusing position of the lens corresponding to the projection distance is inquired based on the corresponding relationship table, and finally, the focusing unit is controlled to move the lens to the focusing position to implement automatic focusing. In this way, it is ensured that the projection screen is clear.

It should be noted that in the above various embodiments, the steps are not subject to a definite order during execution, and persons of ordinary skill in the art would understand, based on the description of the embodiments of the present application, in different embodiments, the above steps may be performed in different orders, that is, may be concurrently performed, or alternately performed.

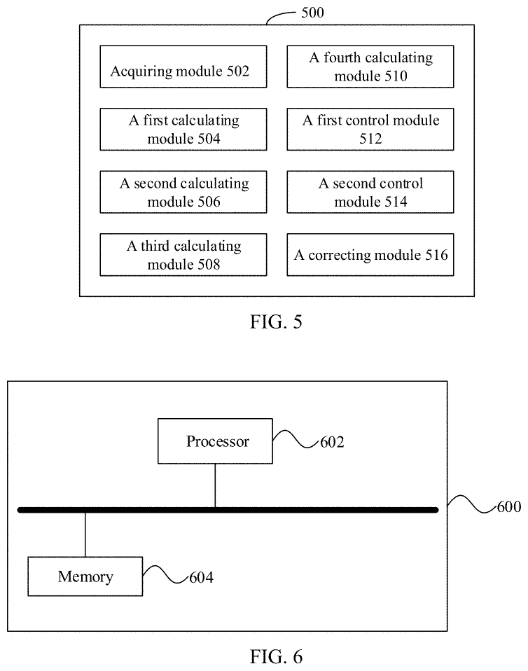

Correspondingly, an embodiment of the present application further provides a dynamic projection device 500 for target tacking. As illustrated in FIG. 5, includes:

an acquiring module 502, configured to acquire position information of a target;

a first calculating module 504, configured to determine three-dimensional spatial coordinates of the target in a first coordinate system based on the position information of the target;

a second calculating module 506, configured to determine three-dimensional spatial coordinates of the target in a second coordinate system based on the three-dimensional spatial coordinates of the target in the first coordinate system;

a third calculating module 508, configured to determine a deflection angle of a projection screen based on the three-dimensional spatial coordinates of the target in the second coordinate system;

a fourth calculating module 510, configured to determine a rotation angle of the motion control unit based on the deflection angle;

a first control module 512, configured to control the motion control unit to rotate by the rotation angle; and

a second control module 514, configured to control the projecting unit to project the projection screen.

In the dynamic projection device for target tracking according to the embodiment of the present application: the acquiring module acquires position information of a target; the first calculating module determines three-dimensional spatial coordinates of the target in a first coordinate system based on the position information of the target; the second calculating module determines three-dimensional spatial coordinates of the target in a second coordinate system based on the three-dimensional spatial coordinates of the target in the first coordinate system; the third calculating module determines a deflection angle of a projection screen based on the three-dimensional spatial coordinates of the target in the second coordinate system; further, the fourth calculating module calculates a rotation angle of a motion control unit based on the deflection angle; the first control module controls the motion control unit to rotate by the rotation angle; and the second control module controls the projecting unit to project the projection screen. In this way, dynamic projection for target tracking is implemented.

Optionally, in other embodiments of the apparatus, referring to FIG. 5, the device 500 further includes:

a correcting module 516, configured to correct the projection screen.

Optionally, in other embodiments of the device, the first calculating module 504 is specifically configured to:

establish the first coordinate system with the sensing unit as an origin; and

calculate the three-dimensional spatial coordinates of the target in the first coordinate system according to a distance, an azimuth, and an elevation angle, wherein the distance is a length between the sensing unit and the target, the azimuth is a horizontal angle between the sensing unit and the target, and the elevation angle is a vertical angle between the sensing unit and the target.

calculate the three-dimensional spatial coordinates of the target in the first coordinate system according to the distance, the azimuth, and the elevation angle by using the following formula:

xₛ=Rₛ cos βₛ sin αₛ

yₛ=Rₛ cos βₛ cos αₛ

zₛ=Rₛ sin βₛ

wherein xₛ, yₛ, zₛ are the three-dimensional coordinates of the target in the first coordinate system, R_{S} is the length between the sensing unit and the target, α_{S} is the horizontal angle between the sensing unit and the target, and β_{S} is the vertical angle between the sensing unit and the target.

Optionally, in other embodiments of the device, the second calculating module 506 is specifically configured to:

establish the second coordinate system with an axial center of the rotation shaft as an origin, wherein the second coordinate system is in corresponding relationship with the first coordinate system; and

determine the three-dimensional spatial coordinates of the target in the second coordinate system based on the three-dimensional spatial coordinates of the target in the first coordinate system and the corresponding relationship.

The second coordinate system is parallel to the first coordinate system.

The three-dimensional spatial coordinates of the target in the second coordinate system are calculated by using the following formula:

xₚ=xₛ+xₛ₀=Rₛ cos βₛ sin αₛ+xₛ₀

yₚ=yₛ+yₛ₀=Rₛ cos βₛ cos αₛ+yₛ₀

zₚ=zₛ+zₛₒ=Rₛ sin βₛ+zₛ₀

wherein xₚ, yₚ, zₚ are the three-dimensional spatial coordinates of the target in the second coordinate system, and xₛ₀, yₛ₀, zₛ₀ are coordinates of the sensing unit in the second coordinate system.

Optionally, in other embodiments of the device, the third calculating module 508 is specifically configured to:

determine the deflection angle of the projection screen based on the three-dimensional spatial coordinates of the target in the second coordinate system by using the following formula:

$${α}_{p} = {sin}^{- 1} \frac{{x}_{p}}{\sqrt{{x}_{p}^{2} + {y}_{p}^{2}}} = {cos}^{- 1} \frac{{y}_{p}}{\sqrt{{x}_{p}^{2} + {y}_{p}^{2}}} \\ {β}_{p} = {sin}^{- 1} \frac{{z}_{p}}{\sqrt{{x}_{p}^{2} + {y}_{p}^{2} + {z}_{p}^{2}}}$$

wherein αₚ, βₚ is the deflection angle of the projection screen relative to the projecting unit.

Optionally, in other embodiments of the device, the fourth calculating module 510 is specifically configured to:

determine the rotation angle of the dynamic control unit based on the deflection angle by using the following formula:

Δα=αₚ⁽ⁱ⁺¹⁾−αₚ⁽ⁱ⁾

Δβ=βₚ⁽ⁱ⁺¹⁾−βₚ⁽ⁱ⁾

wherein αₚ⁽ⁱ⁾ and βₚ⁽ⁱ⁾ are the deflection angles of the projection screen, αₚ⁽ⁱ⁺¹⁾ and βₚ⁽ⁱ⁺¹⁾ are deflection angles corresponding to the target, Δα is a rotation angle of the dynamic control unit in a horizontal direction, and Δβ is a rotation angle of the dynamic control unit in a vertical direction.

It should be noted that the above dynamic projection device for target tracking is capable of performing the dynamic projection method for target tracking according to the embodiments of the present application, includes the corresponding function modules to perform the methods, and achieves the corresponding beneficial effects. For technical details that are not illustrated in detail in this embodiment, reference may be made to the description of the method according to the embodiment of the present application.

FIG. 6 is a schematic structural diagram illustrating hardware of a controller 600 according to an embodiment of the present application.

As illustrated in FIG. 6, the controller 600 includes one or more processors 602, and a memory 604. FIG. 6 uses one processor 602 as an example.

The processor 602 and the memory 604 may be connected via a bus or in another manner, and FIG. 6 uses the bus as an example.

The memory 604, as a non-volatile computer readable storage medium, may be configured to store non-volatile software programs, non-volatile computer executable programs and modules, for example, the programs, instructions, and modules corresponding to the dynamic projection method for target tracking according to the embodiments of the present application. The non-volatile software programs, instructions and modules stored in the memory 604, when being executed, cause the processor 602 to perform various function applications and data processing of the dynamic projection equipment, that is, performing the dynamic projection method for target tracking according to the above method embodiments.

The memory 604 may include a program memory area and data memory area, wherein the program memory area may store operation systems and application programs needed by at least function; and the data memory area may store data created according to the usage of the dynamic projection device for target tracking. In addition, the memory 604 may include a high-speed random-access memory, or include a non-volatile memory, for example, at least one disk storage equipment, a flash memory equipment, or another non-volatile solid storage equipment. In some embodiments, the memory 604 optionally includes memories remotely configured relative to the processor 602. These memories may be connected to the dynamic projection device for target tracking over a network. Examples of the above network include, but not limited to, the Internet, Intranet, local area network, mobile communication network and a combination thereof.

One or more modules are stored in the memory 604, which, when executed by the one or more controllers 600, are caused to perform the dynamic projection method for target tracking according to any of the above method embodiments, for example, performing steps 202 to 214 in the method as illustrated in FIG. 2, and implementing the functions of the modules 502 to 516 as illustrated in FIG. 5.

The product may perform the method according to the embodiments of the present application, has corresponding function modules for performing the method, and achieves the corresponding beneficial effects. For technical details that are not illustrated in detail in this embodiment, reference may be made to the description of the methods according to the embodiments of the present application.

An embodiment of the present application further provides a non-volatile computer-readable storage medium. The non-volatile computer-readable storage medium stores at least one computer-executable instruction, which, when executed by one or more processors, causes the one or more processors to perform the dynamic projection method for target tracking according to any one of the above embodiments.

The above described apparatus embodiments are merely for illustration purpose only. The units which are described as separate components may be physically separated or may be not physically separated, and the components which are illustrated as units may be or may not be physical units, that is, the components may be located in the same position or may be distributed into a plurality of network units. A part or all of the modules may be selected according to the actual needs to achieve the objectives of the technical solutions of the embodiments.

According to the above embodiments of the present application, a person skilled in the art may clearly understand that the embodiments of the present application may be implemented by means of hardware or by means of software plus a necessary general hardware platform. Persons of ordinary skill in the art may understand that all or part of the steps of the methods in the embodiments may be implemented by a program instructing relevant hardware. The program may be stored in a computer readable storage medium and may be executed by at least one processor. When the program runs, the steps of the methods in the embodiments are performed. The storage medium may be any medium capable of storing program codes, such as a read-only memory (ROM), a random-access memory (RAM), a magnetic disk, or a compact disc read-only memory (CD-ROM).

Finally, it should be noted that the above embodiments are merely used to illustrate the technical solutions of the present application rather than limiting the technical solutions of the present application. Under the concept of the present application, the technical features of the above embodiments or other different embodiments may be combined, the steps therein may be performed in any sequence, and various variations may be derived in different aspects of the present application, which are not detailed herein for brevity of description. Although the present application is described in detail with reference to the above embodiments, persons of ordinary skill in the art should understand that they may still make modifications to the technical solutions described in the above embodiments, or make equivalent replacements to some of the technical features; however, such modifications or replacements do not cause the essence of the corresponding technical solutions to depart from the spirit and scope of the technical solutions of the embodiments of the present application.

What is claimed is:

1. A dynamic projection method for target tracking, applicable to a dynamic projection equipment, the dynamic projection equipment comprising a motion control unit and a projecting unit, the motion control unit being configured to control rotation of the projecting unit; wherein the method comprises:
acquiring position information of a target;
determining three-dimensional spatial coordinates of the target in a first coordinate system based on the position information of the target;
determining three-dimensional spatial coordinates of the target in a second coordinate system based on the three-dimensional spatial coordinates of the target in the first coordinate system;
determining a deflection angle of a projection screen based on the three-dimensional spatial coordinates of the target in the second coordinate system;
determining a rotation angle of the motion control unit based on the deflection angle;
controlling the motion control unit to rotate by the rotation angle;
controlling the projecting unit to project the projection screen.

2. The method according to claim 1, wherein the dynamic projection equipment further comprises a sensing unit;
determining the three-dimensional spatial coordinates of the target in the first coordinate system based on the position information of the target comprises:
establishing the first coordinate system with the sensing unit as an origin;
calculating the three-dimensional spatial coordinates of the target in the first coordinate system according to a distance, an azimuth, and an elevation angle, wherein the distance is a length between the sensing unit and the target, the azimuth is a horizontal angle between the sensing unit and the target, and the elevation angle is a vertical angle between the sensing unit and the target.

3. The method according to claim 2, wherein the three-dimensional spatial coordinates of the target in the first coordinate system are calculated according to the distance, the azimuth, and the elevation angle by using the following formula:
xₛ=Rₛ cos βₛ sin αₛ
yₛ=Rₛ cos βₛ cos αₛ
zₛ=Rₛ sin βₛ
wherein xₛ, yₛ, zₛ are the three-dimensional coordinates of the target in the first coordinate system, R_{S} is the length between the sensing unit and the target, α_{S} is the horizontal angle between the sensing unit and the target, and β_{S} is the vertical angle between the sensing unit and the target.

4. The method according to claim 1, wherein the motion control unit comprises a rotation shaft;
determining the three-dimensional spatial coordinates of the target in the second coordinate system based on the three-dimensional spatial coordinates of the target in the first coordinate system comprises:
establishing the second coordinate system with an axial center of the rotation shaft as an origin, wherein the second coordinate system is in corresponding relationship with the first coordinate system;
determining the three-dimensional spatial coordinates of the target in the second coordinate system based on the three-dimensional spatial coordinates of the target in the first coordinate system and the corresponding relationship.

5. The method according to claim 4, wherein the second coordinate system is parallel to the first coordinate system;
the three-dimensional spatial coordinates of the target in the second coordinate system are calculated by using the following formula:
xₚ=xₛ+xₛ₀=R_{S} cos βₛ sin αₛ+xₛ₀
yₚ=yₛ+yₛ₀=R_{S} cos βₛ cos αₛ+yₛ₀
zₚ=zₛ+zₛ₀=R_{S} sin βₛ+zₛ₀
wherein xₚ, yₚ, zₚ are the three-dimensional spatial coordinates of the target in the second coordinate system and xₛ₀, yₛ₀, zₛ₀ are coordinates of the sensing unit in the second coordinate system.

6. The method according to claim 5, wherein the deflection angle of the projection screen is determined based on the three-dimensional spatial coordinates of the target in the second coordinate system by using the following formula:
$${α}_{p} = {sin}^{- 1} \frac{{x}_{p}}{\sqrt{{x}_{p}^{2} + {y}_{p}^{2}}} = {cos}^{- 1} \frac{{y}_{p}}{\sqrt{{x}_{p}^{2} + {y}_{p}^{2}}} \\ {β}_{p} = {sin}^{- 1} \frac{{z}_{p}}{\sqrt{{x}_{p}^{2} + {y}_{p}^{2} + {z}_{p}^{2}}}$$
wherein αₚ, βₚ is the deflection angle of the projection screen relative to the projecting unit.

7. The method according to claim 6, wherein the rotation angle of the motion control unit is determined based on the deflection angle by using the following formula:
Δα=αₚ⁽ⁱ⁺¹⁾−αₚ⁽ⁱ⁾
Δβ=βₚ⁽ⁱ⁺¹⁾−βₚ⁽ⁱ⁾
wherein αₚ⁽ⁱ⁾ and βₚ⁽ⁱ⁾ are the deflection angles of the projection screen, αₚ⁽ⁱ⁺¹⁾ and βₚ⁽ⁱ⁺¹⁾ are deflection angles corresponding to the target, Δα is a rotation angle of the motion control unit in a horizontal direction, and Δβ is a rotation angle of the motion control unit in a vertical direction.

8. The method according to claim 1, further comprising:
correcting the projection screen.

9. A dynamic projection equipment, comprising:
a sensing unit, a calculating unit, a motion control unit, a projecting unit, and a controller; wherein
the sensing unit is connected to the calculating unit, the calculating unit is connected to the motion control unit, the motion control unit is connected to the projecting unit, and the controller is connected to the sensing unit, the calculating unit, the motion control unit, and the projecting unit;
the sensing unit is configured to acquire position information of a target;
the calculating unit is configured to calculate three-dimensional spatial coordinates and a rotation angle desired by the motion control unit; and
the motion control unit is configured to control the projecting unit to rotate;
wherein the controller comprises:
at least one processor; and
a memory communicably connected to the at least one processor; wherein
the memory is configured to store at least one instruction executable by the at least one processor, wherein the at least one instruction, when executed by the at least one processor, causes the at least one processor to perform:
acquiring position information of a target;
determining three-dimensional spatial coordinates of the target in a first coordinate system based on the position information of the target;
determining three-dimensional spatial coordinates of the target in a second coordinate system based on the three-dimensional spatial coordinates of the target in the first coordinate system;
determining a deflection angle of a projection screen based on the three-dimensional spatial coordinates of the target in the second coordinate system;
determining a rotation angle of the motion control unit based on the deflection angle;
controlling the motion control unit to rotate by the rotation angle;
controlling the projecting unit to project the projection screen.

10. A non-volatile computer-readable storage medium storing at least one computer-executable instruction, wherein the at least one computer-executable instruction, when executed by a processor, causes the processor to perform:
acquiring position information of a target;
determining three-dimensional spatial coordinates of the target in a first coordinate system based on the position information of the target;
determining three-dimensional spatial coordinates of the target in a second coordinate system based on the three-dimensional spatial coordinates of the target in the first coordinate system;
determining a deflection angle of a projection screen based on the three-dimensional spatial coordinates of the target in the second coordinate system;
determining a rotation angle of the motion control unit based on the deflection angle;
controlling the motion control unit to rotate by the rotation angle;
controlling the projecting unit to project the projection screen.
